(19) United States
(12) Patent Application Publication
(10) Pub. No.: US 2005/0125448 A1
(43) Pub. Date: Jun. 9, 2005

(54) Systems and methods for managing processes

(76) Inventor: Brad S. Perry, North Salt Lake, UT (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 10/730,370

(22) Filed: Dec. 5, 2003

(51) Int. Cl. G06F 7/00

(52) U.S. Cl. 707/104.1

(57) ABSTRACT

Systems and methods for managing a process. More particularly, a secure, global computer network-based application that tracks and manages the steps of a defined process from start to finish. The application is accessible by multiple parties and automatically notifies pre-selected parties when certain milestones are reached. The application also has the ability to document information relevant to the completion of an assigned task.

### BACKGROUND OF THE INVENTION

1. Field of the Invention

The present invention relates to process management. More particularly, the present invention relates to a method and system for managing processes.

2. Background and Related Art

Communication challenges related to process management often result in information loss, unnecessary job duplication and other inefficiencies. These communication challenges are sometimes the product of people working in different locations, or result from poor process management. Process management problems are often magnified when companies outsource certain tasks, especially when the tasks are a part of a process.

Even when companies do not outsource, tasks may be delegated in such a way that makes process management difficult either because of the large number of tasks and people involved in the process or because of the time it takes to clearly communicate progress updates. While some organizations formally assign coordination responsibilities, this can also be inefficient because of the time and effort it takes to coordinate and communicate updates. Also, assigning a process manager adds a layer of communication, increasing the chances for information loss and keeping that person from doing other, more productive tasks. Even greater problems arise when no formal coordination takes place. Process management is especially challenging in a parallel process where related tasks are competed at the same time. Also, even when an organization engages in a linear process, where each task must be completed in a certain order, coordinating and documenting the task completion can be cumbersome.

Additional problems arise when dealing with multiple organizations. For instance, each organization typically has its own system for process management. While a system may work efficiently for internal use, it is typically inefficient for one organization to access the process management systems of other organizations in order to receive progress updates.

### SUMMARY OF THE INVENTION

The present invention relates to process management. More particularly, the present invention relates to a method and system for managing processes.

Implementation of the present invention takes place in association with a process and a communication medium. In one implementation, a global computer network-based application tracks the steps of a defined process from start to finish. The application is accessible by multiple parties and automatically notifies pre-selected parties when certain milestones are reached. The application also has the ability to document information relevant to the completion of an assigned task.

In another implementation, the global computer network-based application is secure, where only selected parties can access the application. Personalized accounts are created and passwords are used in order to control access.

In another implementation, the application contacts and updates selected parties via a form of electronic communication, such as email. In some implementations, only a second service provider and monitoring individuals are notified through a message sent over the global computer network when a first task is completed.

In yet another implementation, a linear process is tracked, where the system automatically notifies the appropriate person when a task is completed.

In another implementation, a parallel process is managed.

In another implementation, a process is defined in flow chart form, and then entered into the tool.

In another implementation, the application estimates and documents the amount of time a step should take. The application can also give deadlines. These deadlines can be specific dates or can be floating periods, where the completion of subsequent steps is dependent upon previous steps.

In another implementation of the present invention, a first service provider manipulates an original group of data. This manipulated group of data is forwarded along with the original group of data to the second service provider for further manipulation.

In yet another implementation of the present invention, the first service provider categorizes the original group of data. This categorization includes, among many others, the following categories: purchase orders; invoices; payments; and customers. A separate group of data is thereby created, leaving the original group of data in its pristine state.

In an additional implementation of the present invention, once the first service provider's task has been completed and the second service provider has been instructed to begin a second task, the first service provider's access to the computer readable medium through the global computer network becomes limited. In some implementations, the first service provider's access is limited to read-only access. In other implementations, the first service provider's access is limited because the global computer network universal resource locators (URL) changes.

While the methods and processes of the present invention have proven to be particularly useful in the area of processes and global computer network-based applications, those skilled in the art can appreciate that the methods and processes can be used in a variety of different applications and in a variety of different areas of manufacture to yield efficient progress management and tracking.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific implementations thereof, which are illustrated in the appended drawings. Understanding that the drawings depict only typical implementations of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates an example of a networked environment of the representative system of FIG. 1; and

FIG. 3 illustrates a flow chart that provides a representative implementation of the process management system and method.

### DETAILED DESCRIPTION OF THE INVENTION

The present invention relates to process management. More particularly, the present invention relates to a method and system for managing processes.

In the disclosure and in the claims the term “process” shall refer to any process, including linear and parallel processes, that would benefit from a process management system and method such as herein disclosed.

The following disclosure of the present invention is grouped into 2 subheadings, namely “Exemplary Operating Environment” and “System and Method for Managing a Process.” The utilization of the subheadings is for convenience of the reader only and is not to be construed as limiting in any sense.

### Exemplary Operating Environment

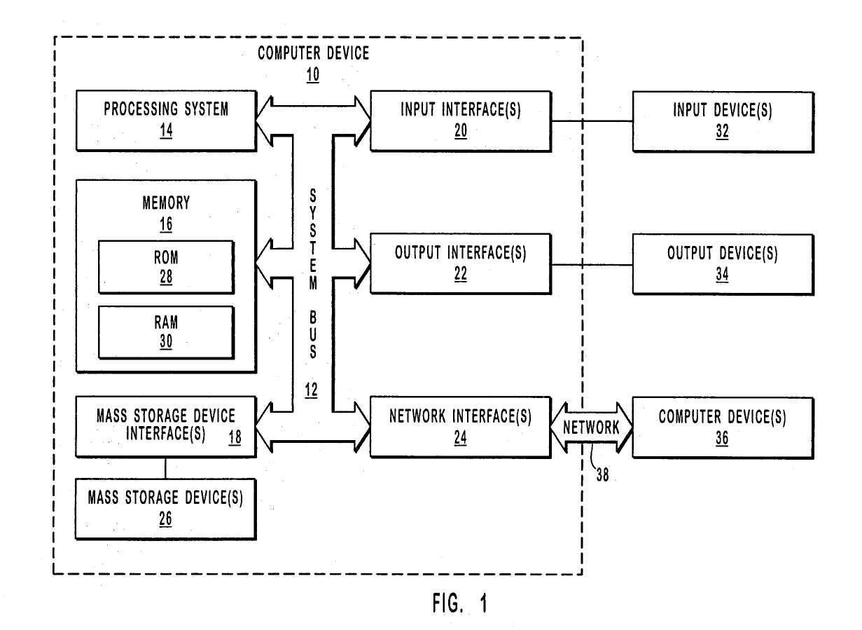

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Implementations of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a global computer or wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

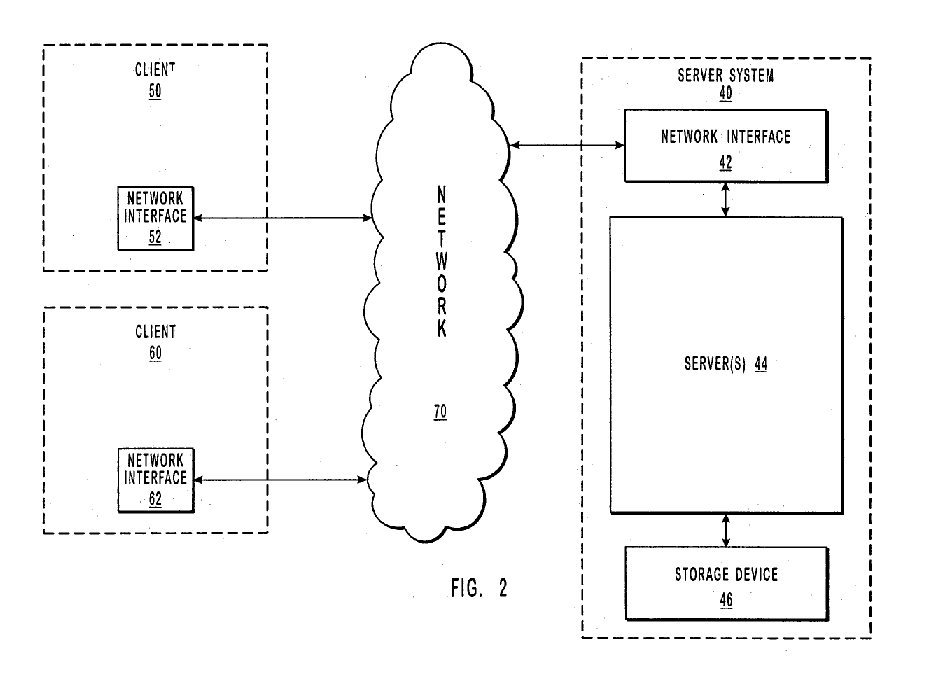

While those skilled in the art will appreciate that the invention may be practiced in networked computing environments with many types of computer system configurations, FIG. 2 represents an implementation of the present invention in a networked environment that includes clients connected to a server via a network. While FIG. 2 illustrates an implementation that includes two clients connected to the network, alternative implementations include one client connected to a network or many clients connected to a network. Moreover, implementations in accordance with the present invention also include a multitude of clients throughout the world connected to a network, where the network is a global computer or wide area network, such as the Internet.

In FIG. 2, a representative networked configuration is provided in which systems and methods for managing processes operate. Server system 40 represents a system configuration that includes one or more servers. Server system 40 includes a network interface 42, one or more servers 44, and a storage device 46. A plurality of clients, illustrated as clients 50 and 60, communicate with server system 40 via network 70, which may include a wireless network, a local area network, and/or a wide area network. Network interfaces 52 and 62 are communication mechanisms that respectfully allow clients 50 and 60 to communicate with server system 40 via network 70. For example, network interfaces 52 and 62 may be a web browser or other network interface. A browser allows for a uniform resource locator (“URL”) or an electronic link to be used to access a web page sponsored by a server 44. Therefore, clients 50 and 60 may independently access or exchange information with server system 40.

As provided above, server system 40 includes network interface 42, servers 44, and storage device 46. Network interface 42 is a communication mechanism that allows server system 40 to communicate with one or more clients via network 70. Servers 44 include one or more servers for processing and/or preserving information. Storage device 46 includes one or more storage devices for preserving information, such as electronic documents having images. Storage device 46 may be internal or external to servers 44.

### System and Method for Managing a Process

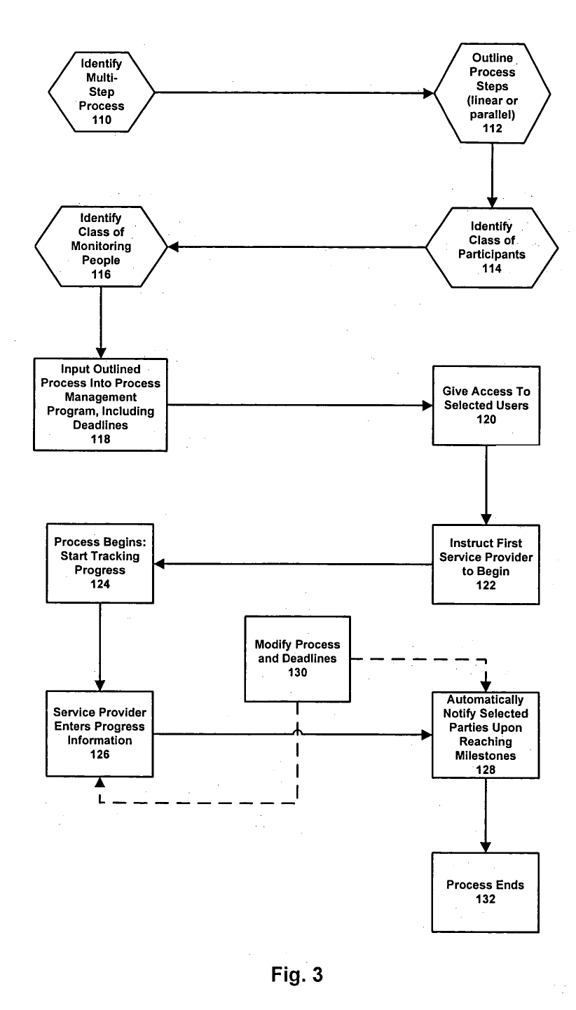

FIG. 3 illustrates a flow chart that provides a representative implementation of the process management system and method. In FIG. 3, execution begins at step 110 where a process is identified. At step 112, the process steps are outlined. In one implementation, the outline consists of a linear process. In another implementation, the outline consists of a parallel process. At step 114, a class of participants is identified and at step 116, a class of monitoring individuals, who monitor the progress of the process, is identified.

Continuing on now to step 118, the outlined process is entered into the process management program. In some implementations, the program estimates and documents the amount of time a step should take, generating a deadline. This deadline can be a specific date or a floating period, where the completion of the next step is dependent upon the previous step.

At step 120, access to the program is given to selected users. In one implementation, this access is limited; allowing the user read-only access. In another implementation, the access is less restrictive, allowing the user to enter relevant data, such as the user's work product. Execution then proceeds to step 122 where a first service provider is instructed to begin the first step of the process. Once the first service provider begins work, the process begins and the progress begins to be tracked and managed at step 124.

At step 126, the first service provider enters progress information. In some implementations, this progress information includes the first service provider's work product. One example of this work product is an electronic document representing the first service provider's contribution to the completion of the process.

Upon reaching milestones, the program automatically notifies selected parties at step 128. In some implementations, this notification signals the next service provider to start his or her part of the process. Step 130 shows a step present in some implementations, where the process and its deadlines are modified. This allows the program to adapt to unexpected changes. Finally, at step 132, the process ends.

In another implementation of the present invention, only the second service provider and the monitoring individuals are notified through a message sent over the global computer network when the first task is completed.

In another implementation of the present invention, the first service provider manipulates an original group of data. This manipulated group of data is forwarded along with the original group of data to the second service provider for further manipulation.

In yet another implementation of the present invention, the first service provider categorizes the original group of data. This categorization includes, among many others, the following categories: purchase orders; invoices; payments; and customers. A separate group of data is thereby created, leaving the original group of data in its pristine state.

In an additional implementation of the present invention, once the first service provider's task has been completed and the second service provider has been instructed to begin a second task, the first service provider's access to the computer readable medium through the global computer network becomes limited. In some implementations, the first service provider's access is limited to read-only access. In other implementations, the first service provider's access is limited because the global computer network universal resource locators (URL) changes.

Thus, as discussed herein, the implementations of the present invention embrace a method and system for tracking processes.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for tracking a process comprising the steps of:
providing a computer readable medium;
identifying a class of participants;
identifying a class of monitoring individuals who monitor the progress of a process through a global computer network;
providing selective access to the computer readable medium through the global computer network to the monitoring individuals;
inputting the process into the computer readable medium;
instructing a first service provider in the class of participants through a message sent over the global computer network to begin a first task in the process and to report progress via the computer readable medium;
receiving the first service provider's progress report to the computer readable medium;
automatically notifying pre-selected participants and monitoring individuals through a message sent over the global computer network when the first task is completed;
instructing a second service provider in the class of participants through a message sent over the global computer network to begin a second task in the process and to report progress via the computer readable medium;
receiving the second service provider's progress report to the computer readable medium; and
automatically notifying the pre-selected participants and the monitoring individuals through a message sent over the global computer network when the second task is completed.

2. The method of claim 1, further comprising giving a deadline wherein the deadline is either a specific date or a floating period.

3. The method of claim 1, further comprising modifying the process.

4. The method of claim 1, wherein the process is linear.

5. The method of claim 1, wherein the process is parallel.

6. The method of claim 1, wherein the process is linear and parallel.

7. The method of claim 1, wherein the first service provider's progress report includes the first service provider's work product.

8. The method of claim 1, wherein once the first service provider has completed the first task and the second service provider has been instructed to begin the second task, the first service provider's access to the computer readable medium through the global computer network becomes limited.

9. A computer program product for implementing within a computer system a method for progress tracking, the computer program product comprising:
a computer readable medium for providing computer program code means utilized to implement the method, wherein the computer program code means is comprised of executable code for implementing the steps of:
identifying a class of participants;
identifying a class of monitoring individuals who monitor the progress of a process through a global computer network;
providing selective access to the computer readable medium through the global computer network to the monitoring individuals;
inputting the process into the computer readable medium;
instructing a first service provider in the class of participants through a message sent over the global computer network to begin a first task in the process and to report progress via the computer readable medium;
receiving the first service provider's progress report to the computer readable medium;
automatically notifying pre-selected participants and monitoring individuals through a message sent over the global computer network when the first task is completed;
instructing a second service provider in the class of participants through a message sent over the global computer network to begin a second task in the process and to report progress via the computer readable medium;
receiving the second service provider's progress report to the computer readable medium; and
automatically notifying the pre-selected participants and the monitoring individuals through a message sent over the global computer network when the second task is completed.

10. The computer program product of claim 9, wherein the computer program code means further comprises executable code for implementing the step of giving a deadline wherein the deadline is either a specific date or a floating period.

11. The computer program product of claim 9, wherein the computer program code means further comprises executable code for implementing the step of modifying the process.

12. The computer program product of claim 9, wherein the process is linear.

13. The computer program product of claim 9, wherein the process is parallel.

14. The computer program product of claim 9, wherein the process is linear and parallel.

15. The computer program product of claim 9, wherein the first service provider's progress report includes the first service provider's work product.

16. A system containing a computer program product, the product comprising:
a computer readable medium for providing computer program code means utilized to implement the method, wherein the computer program code means is comprised of executable code for implementing the steps of:
identifying a class of participants;
identifying a class of monitoring individuals who monitor the progress of a process through a global computer network;
providing selective access to the computer readable medium through the global computer network to the monitoring individuals;
inputting the process into the computer readable medium;
instructing a first service provider in the class of participants through a message sent over the global computer network to begin a first task in the process and to report progress via the computer readable medium;
receiving the first service provider's progress report to the computer readable medium;
automatically notifying pre-selected participants and monitoring individuals through a message sent over the global computer network when the first task is completed;
instructing a second service provider in the class of participants through a message sent over the global computer network to begin a second task in the process and to report progress via the computer readable medium;
receiving the second service provider's progress report to the computer readable medium; and
automatically notifying the pre-selected participants and the monitoring individuals through a message sent over the global computer network when the second task is completed.

17. The system of claim 16, wherein the computer program code means further comprises executable code for implementing the step of giving a deadline wherein the deadline is either a specific date or a floating period.

18. The system of claim 16, wherein the computer program code means further comprises executable code for implementing the step of modifying the process.

19. The system of claim 16, wherein the process is linear.

20. The system of claim 16, wherein the process is parallel.

21. The system of claim 16, wherein the process is linear and parallel.

22. The system of claim 16, wherein the first service provider's progress report includes the first service provider's work product.

23. A method for tracking a process comprising the steps of:
providing a computer readable medium;
identifying a class of participants;
identifying a class of monitoring individuals who monitor the progress of a process through a global computer network;
providing selective access to the computer readable medium through the global computer network to the monitoring individuals;
inputting the process into the computer readable medium;
instructing a first service provider in the class of participants through a message sent over the global computer network to begin a first task in the process and to report progress via the computer readable medium;
receiving the first service provider's progress report to the computer readable medium;
automatically notifying only a second service provider and the monitoring individuals through a message sent over the global computer network when the first task is completed;
instructing a second service provider in the class of participants through a message sent over the global computer network to begin a second task in the process and to report progress via the computer readable medium;
receiving the second service provider's progress report to the computer readable medium; and
automatically notifying the pre-selected participants and the monitoring individuals through a message sent over the global computer network when the second task is completed.

24. A method for tracking a process comprising the steps of:
providing a computer readable medium;
identifying a class of participants;
identifying a class of monitoring individuals who monitor the progress of a process through a global computer network;
providing selective access to the computer readable medium through the global computer network to the monitoring individuals;
inputting the process into the computer readable medium;
instructing a first service provider in the class of participants through a message sent over the global computer network to begin a first task in the process and to report progress via the computer readable medium;
providing an original group of data that the first service provider manipulates;
providing access to a manipulated group of data and the original group of data to the second service provider for further manipulation;
automatically notifying pre-selected participants and monitoring individuals through a message sent over the global computer network when the first task is completed;
instructing a second service provider in the class of participants through a message sent over the global computer network to begin a second task in the process and to report progress via the computer readable medium;
receiving the second service provider's progress report to the computer readable medium; and
automatically notifying the pre-selected participants and the monitoring individuals through a message sent over the global computer network when the second task is completed.

25. The method of claim 24, wherein the original group of data is categorized, creating a categorized group of data while leaving the original group of data in its pristine state.
